(19) United States
(12) Patent Application Publication
(10) Pub. No.: US 2006/0291592 A1
(43) Pub. Date: Dec. 28, 2006

(54) Multi-symbol noncoherent CPM detector

(76) Inventors: Erik S. Perrins, Lawrence, KS (US); Terrance J. Hill, West Chester, OH (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/369,627

(22) Filed: Mar. 7, 2006

Related U.S. Application Data
(63) Continuation-in-part of application No. 11/252,108, filed on Oct. 17, 2005.
(60) Provisional application No. 60/619,101, filed on Oct. 15, 2004.

(51) Int. Cl. H04L 27/06

(52) U.S. Cl. 375/340

(57) ABSTRACT

Three receivers are presented for the general case of noncoherent detection of multi-h continuous phase modulation. All three receivers yield performance gains using multi-symbol observations. The first is an existing receiver which has previously been applied to PCM/FM and is now applied to the Advanced Range Telemetry Tier II waveform. The second and third receivers are presented for the first time in this paper. The existing noncoherent receiver is found to perform poorly (and with high complexity) for the Advanced Range Telemetry Tier II case. For single-symbol observations, the new receivers outperform conventional FM demodulation for both telemetry waveforms, and for multi-symbol observation lengths their performance approaches that of the optimal coherent receiver. The performance is evaluated using computer simulations. Receiver performance is also evaluated using a simple channel model with varying carrier phase. The traditional FM demodulator approach is found to outperform all three receivers as channel conditions worsen.

This application is a continuation-in-part of U.S. patent application Ser. No. 11/252,108, filed Oct. 17, 2005, which claims priority to U.S. Provisional Patent Application Ser. No. 60/619,101, filed Oct. 15, 2004.

### BACKGROUND

This invention is directed to a continuous phase modulation detector. In particular, this invention is directed to a method for continuous phase modulation detection. More particularly, this invention is directed to a multi-h continuous phase modulation detector.

The Advanced Range Telemetry (ARTM) program is a United States Department of Defense tri-service telemetry modernization project whose goal is to assure that all testing and training ranges are able to use telemetry as necessary to carry out their respective missions. Multi-h Continuous Phase Modulation (CPM) has been selected by the ARTM Joint Programs Office as the Tier II ARTM waveform, because it offers significant improvements over both legacy telemetry waveforms such as pulse width modulation/frequency modulation (“PCM/FM”) and the previous Tier I waveform known as the Feher-patented quadrature-phase-shift keying (“FQPSK”) in terms of spectral containment and detection efficiency, while retaining a constant envelope characteristic.

The ARTM Tier II modulation format is a multi-h continuous phase modulation. Those skilled in the art will appreciate that the multi-h continuous phase modulation format has a constant envelope and narrow bandwidth. Current implementations of receivers for multi-h continuous phase modulation experience several difficulties, including that the branch metrics are solely a function of the data in the multi-symbol observation window. That is, the influence of previous observations is not passed along in the form of a cumulative path metric. The skilled artisan will appreciate that the performance improves as the multi-symbol observation length increases; however, the penalty for this is that trellis complexity increases exponentially with increasing observation length. In addition, the current implementations perform poorly for practical multi-symbol observation lengths with respect to the Advanced Range Telemetry Tier II modulation format. Thus, the existing optimal maximum likelihood sequence estimation receiver for continuous phase modulation may have high complexity, both in trellis size and coherent demodulation requirements.

In view of the aforementioned needs, there is provided in accordance with the present invention an improved, noncoherent receiver capable of allowing multi-symbol observation.

### SUMMARY OF INVENTION

In accordance with the present invention, there is provided a continuous phase modulation detector.

Further, in accordance with the present invention, there is provided a method for continuous phase modulation detection.

Still further, in accordance with the present invention, there is provided a noncoherent receiver capable of allowing multi-symbol observation.

In accordance with the present invention, there is provided a continuous phase modulation detector. The continuous phase modulation detector includes receiver means adapted to receive digitally modulated signals having a generally continuous phase. The detector also includes observation means adapted to perform multi-symbol observations on received digitally modulated signals. Memory means are included in the detector and adapted to store historic observation data corresponding to multi-symbol observations performed by the observation means. The detector further includes adjustment means.

In one embodiment of the present invention, the receiver means is noncoherent and preferably has a trellis structure. The observation means allow for adjusting of a multi-symbol observation length and provide for acquiring cumulative observation data. In a preferred embodiment, controlled use of acquired cumulative observation data is provided, wherein the reliance on past observations is adjusted recursively in accordance with cumulatively acquired observation data. Preferably, the adjustment is based on a “forget factor”. Using the adjusted cumulative metric, the detector of this embodiment is able to perform well while keeping the multi-symbol observation length to a minimum. In one embodiment complex-valued cumulative observation data is evaluated. In another preferred embodiment evaluation of real-valued observation data is performed. These embodiments are equally applicable to both PCM/FM and ARTM Tier II waveforms. In the context of PCM/FM, a two-symbol observation length (4 trellis states) is a few tenths of a dB inferior to the optimal maximum likelihood sequence estimating receiver, and is 3.5 dB superior to conventional FM demodulation. In the context of ARTM Tier II, the same two symbol observation length (64 states) is 2 dB inferior to the maximum likelihood sequence estimating receiver and 4 dB superior to FM demodulation.

Further, in accordance with the present invention, there is provided a method for continuous phase modulation detection. The method begins with the receipt of digitally modulated signals having a generally continuous phase. In a preferred embodiment of the present invention, a noncoherence reception of digitally modulated signals is provided. Multi-symbol observations are then performed on the received digitally modulated signals. In accordance with a predetermined performance, a multi-symbol observation length is adjusted and cumulative observation data resulting from multi-symbol observations is then acquired. Historic observation data corresponding to multi-symbol observations performed on the digitally modulated signals is then stored in a memory. In a preferred embodiment, the amount of acquired cumulative observation data being stored is selectively adjusted according to the stored historic observation data.

In this embodiment of the present invention, the use of a cumulative metric is controlled, wherein the reliance on past observations is adjusted recursively according to the cumulatively acquired observation data. In the preferred embodiment, the adjustment is based on a forget factor. Acquired cumulative observation data is evaluated, wherein in one embodiment complex-valued observation data is evaluated. In another preferred embodiment, evaluation is performed for real-valued observation data.

Still other objects and aspects of the present invention will become readily apparent to those skilled in this art from the following description wherein there is shown and described a preferred embodiment of this invention, simply by way of illustration of one of the best modes suited for to carry out the invention. As it will be realized by those skilled in the art, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The subject invention is described in connection with the attached drawings which are for the purpose of illustrating the preferred embodiment only, and not for the purpose of limiting the same, wherein:

FIG. 1A illustrates graphically performance curves for a PCM/FM waveform of the subject invention;

FIG. 1B illustrates graphically performance curves for a PCM/FM waveform of the subject invention;

FIG. 2A illustrates graphically additional performance curves in connection with the subject invention;

FIG. 2B illustrates graphically additional performance curves in connection with the subject invention;

FIG. 3 illustrates a demodulator diagram and equations in connection with the subject invention;

FIG. 4 illustrates graphically characteristics of PCM/FM demodulators, including those of the present invention;

FIG. 5 illustrates graphically modulation index tracking results as modulation index varies from h=0.6 to h=0.8 in connection with the present invention;

FIG. 6 illustrates graphical a modulation index offset in connection with the present invention;

FIG. 7 illustrates graphically additional modulation index offset in connection with the present invention;

FIG. 8 illustrates graphically additional modulation index offset in connection with the present invention; and

FIG. 9 illustrates graphically characteristics of PC/FM demodulators, including those of the present invention.

### DETAILED DESCRIPTION OF THE PREFERRED AND ALTERNATE EMBODIMENTS

The present invention is directed to a noncoherent receiver capable of allowing multi-symbol observation. In particular, the present invention is directed to a continuous phase modulation detector and method for continuous phase modulation detection.

Continuous phase modulation refers to a general class of digitally modulated signals in which the phase is constrained to be continuous. The complex-baseband signal is expressed as:

$$\begin{matrix}s ( t ) = exp ( jψ ( t , α ) ) & ( 1 ) \\ ψ ( t , α ) = 2 π {\sum }_{i = - ∞}^{n} {α}_{i} {h}_{( i )} q ( t - ⅈ T ) , nT < t < ( n + 1 ) T & ( 2 )\end{matrix}$$

where T is the symbol duration, h₍ᵢ₎ are the modulation indices, α={αᵢ} are the information symbols in the M-ary alphabet {±1, ±3, . . .±(M−1)}, and q(t) is the phase pulse. The subscript notation on the modulation indices is defined as:
h₍ᵢ₎≡h_{(i mod N}_{ₕ}₎ (3)
where Nₕ is the number of modulation indices (for the special case of single-h continuous phase modulation, Nₕ=1). The phase pulse q(t) is related to the frequency pulse f(t) by the relationship:

$$q ( t ) = {\int }_{0}^{t} f ( τ ) ⅆ τ . \qquad ( 4 )$$

The frequency pulse is time-limited to the interval (0,LT) and is subject to the constraints:

$$f ( t ) = f ( LT - t ) , {\int }_{0}^{LT} f ( τ ) ⅆ τ = q ( LT ) = \frac{1}{2} \qquad ( 5 )$$

In light of the constraints on f(t) and q(t), Equation (2) is suitably written as:

$$\begin{matrix}ψ ( t , α ) = θ ( t , {α}_{n} ) + {θ}_{n - L} \\ = 2 π {\sum }_{i = n - L + 1}^{n} {α}_{i} {h}_{( i )} q ( t - ⅈ T ) + π {\sum }^{} {a}_{i} {h}_{i } mod 2 π .\end{matrix} \qquad ( 6 )$$

The term θ(t,αₙ) is a function of the L symbols being modulated by the phase pulse. For h₍ᵢ₎=2k₍ᵢ₎/p (k₍ᵢ₎, p integers), the phase state θ_{n-L} takes on p distinct values 0, 2π/p,2·2π/p, . . . , (p−1) 2π/p. The total number of states is pM^{L-1}, with M branches at each state. Each branch is defined by the L+1-tuple σₙ=(θ_{n-L}, α_{n-L+1}, α_{n-L+2}, . . . , αₙ). The Advanced Range Telemetry Tier II modulation is M=4, h={4/16, 5/16} (Nₕ=2), 3RC (raised cosine frequency pulse of length L=3).

In accordance with the present invention, the model for the received complex-baseband signal is denoted by the equation:
r(t)=s(t,α)e^{jφ(t)}+n(t) (7)
wherein n(t)=x(t)+jy(t) is complex-valued additive white Gaussian noise with zero-mean and single-sided power spectral density N₀. The phase shift φ(t) introduced by the channel is unknown in general.

Those skilled in the art will appreciate that there are a plurality of instances wherein this signal model is considered. For example and without limitation, the binary continuous phase frequency shift keying (“CPFSK”)case assumes φ(t) to be uniformly distributed over the interval [−π,π]. It is also assumed to be slowly varying so that it is constant over a multi-symbol observation interval NT. The receiver correlates the received signal against all possible transmitted sequences of length NT and outputs the maximum likelihood decision on the middle bit in the observation.

With respect to the more general continuous phase modulation example, φ(t) is modeled as a slowly varying process with the Tikhonov distribution. The Tikhonov distribution is parameterized by β and has three important special cases: the fully coherent case where β=∞, the noncoherent case where β=0 and φ(t) reduces to a uniformly distributed value over [−π, π], and the partially coherent case where 0<β<∞. A practical receiver is then given for the noncoherent case (β=0), which is a generalization of the CPFSK receiver. This more general receiver has the complex-valued decision variable:

$$\begin{matrix}\begin{matrix}{λ}_{\tilde{α}} ( n ) = {\int }_{( n - {N}_{1} ) T}^{( n + {N}_{2} ) T} r ( τ ) {ⅇ}^{- jθ ( τ , \tilde{α} )} {ⅇ}^{- j {\tilde{θ}}_{k - L}} ⅆ τ , nT < t < ( n + 1 ) T \\ kT \leq τ \leq ( k + 1 ) T \\ = {λ}_{\tilde{α}} ( n - 1 ) - {ⅇ}^{- j {\tilde{θ}}_{n - 1 - L - {N}_{1}}} {\int }_{( n - 1 - {N}_{1} ) T}^{( n - {N}_{1} ) T} r ( τ ) {ⅇ}^{- j θ ( τ - \tilde{α} )} ⅆ τ + \\ {ⅇ}^{- j {\tilde{θ}}_{n - 1 - L + {N}_{2}}} {\int }_{( n - 1 + {N}_{2} ) T}^{( n + {N}_{2} ) T} r ( τ ) {ⅇ}^{- j θ ( τ - \tilde{α} )} ⅆ τ\end{matrix} & \begin{matrix}\begin{matrix}( 8 ) \\ ( 9 )\end{matrix} \\ \end{matrix} \\ {\tilde{θ}}_{k - L} = π {\sum }_{l = - ∞}^{k - L} {\tilde{α}}_{l} {h}_{( l )} mod 2 π & ( 10 )\end{matrix}$$

where \tilde{α} is a hypothesized data sequence and the observation interval is N₁+N₂=N symbol times. The term \tilde{θ}_{k-L} accumulates the phase of the hypothesized symbols after they have been modulated by the length-LT phase pulse e^{-jθ(τ,\tilde{α})}; it is necessary to match the phase of the individual length-T segments of the integral in Equation (8). Equation (9) shows that this metric is suitably computed recursively using the Viterbi algorithm with a trellis of M^{L+N-2} states. It is important to point out that the recursion does not maintain a cumulative path metric, but rather functions as a sliding window that sums N individual length-T correlations (each rotated by the proper phase). The receiver does not perform a traceback operation to determine the output symbol, but instead outputs the symbol \tilde{α}ₙ corresponding to the metric λ_{\tilde{α}}(n) with the largest magnitude (the symbol \tilde{α}ₙ is the N₁-th symbol in the length-N observation, which is not necessarily the middle symbol). Since φ(t) is assumed to be constant over the N-symbol observation interval, the magnitude of the metric λ_{\tilde{α}}(n) is statistically independent of the channel pulse.

There are two difficulties with the receiver described by Equation (8). The first difficulty is the number of states grows exponentially with the observation interval N. The second difficulty is that, depending on the particular continuous phase modulation scheme, a large value for N is capable of being required to achieve adequate performance.

According to the present invention, the preceding difficulties are addressed by the receiver described the recursive metric:

$$\begin{matrix}{λ}_{\tilde{α}} ( n ) = a {λ}_{\tilde{α}} ( n - 1 ) + {ⅇ}^{- j {\hat{θ}}_{n - L}^{( i )}} {z}_{\tilde{α}} ( n ) & ( 11 ) \\ {z}_{\tilde{α}} ( n ) = {\int }_{nT}^{( n + 1 )} r ( τ ) {ⅇ}^{- jθ ( τ , \tilde{α} )} ⅆ τ & ( 12 ) \\ {\hat{θ}}_{n - L}^{( i )} = π {\sum }_{k = - ∞}^{k - L} {\hat{α}}_{k}^{( i )} {h}_{( k )} mod 2 π & ( 13 )\end{matrix}$$

wherein the forget factor α is in the range 0≦α≦1. The term \hat{θ}_{n-L}⁽ⁱ⁾ represents the phase contribution of all previous symbol decisions \hat{α}ₖ⁽ⁱ⁾ for the i-th state in the trellis. Each state in the trellis stores two values: a cumulative metric λ_{\tilde{α}}(n−1), and a cumulative phase \hat{θ}_{n-L}⁽ⁱ⁾. The receiver uses a traceback matrix of length DD to output the symbol \hat{α}_{n-DD}⁽ⁱ⁾ corresponding to the state whose metric has the largest magnitude. Here, the branch metric λ_{\tilde{α}}(n) is only a function of the L symbols being modulated by the phase pulse q(t), thus the number of states is M^{L-1}. For the special case of α=1 this branch metric reduces to:

$$\begin{matrix}{λ}_{\tilde{α}} ( n ) = {\sum }_{k = - ∞}^{k - L} {a}^{n - i} {ⅇ}^{- j {\hat{θ}}_{k - L}^{( i )}} {\int }_{kT}^{( k + 1 ) T} r ( τ ) {ⅇ}^{- jθ ( τ , \tilde{α} )} ⅆ τ \\ = {\int }_{- ∞}^{( n + {N}_{1} ) T} r ( τ ) {ⅇ}^{- jθ ( τ , \tilde{α} )} {ⅇ}^{- j {\hat{θ}}_{k - L}} ⅆ τ , kT \leq τ \leq ( k + 1 ) T\end{matrix} \qquad \begin{matrix}( 14 ) \\ ( 15 )\end{matrix}$$

This identifies an important tradeoff. As α approaches unity, the branch metric in Equation (11) approaches the one in Equation (15). The metric in Equation (15) is a loose approximation to an infinitely long observation interval because it “remembers” previous observations through the use of a cumulative metric. The optimal maximum likelihood sequence estimating receiver also uses a cumulative metric to recursively compute a correlation from (∞,(n+1)T). The only difference is the non-coherent receiver cannot account for the phase states θ_{n-L} (shown in Equation (6)) in the trellis since the magnitude of the metrics (rather than the real part for the maximum likelihood sequence estimating receiver case) is used to determine survivors. However, when the slowly varying channel phase φ(t) is taken into account, the branch metric in Equation (15) will trace a curved path in the complex plane as φ(t) changes. This will reduce the magnitude of the metric and increase the probability that the competing paths through the trellis will have metrics with a magnitude larger than the true path. As α approaches zero, the branch metrics “forget” the infinite past more quickly and allow φ(t) to change more rapidly with less impact on the magnitude of the branch metrics.

Those of ordinary skill in the art will appreciate that the metric, described in Equation (11), is capable of being extended to more closely approximate an infinitely long observation interval. The reason for the inherently loose approximation in Equation (11) is that the trellis only allows for M^{L-1} states, when the underlying continuous phase modulation signal is described by pM^{L-1} states, where the p-fold increase is due to the phase states θ_{n-L}. The extended metric for an observation interval of length N≧1 is given by:

$$\begin{matrix}{λ}_{\tilde{α}} ( n ) = a {λ}_{\tilde{α}} ( n - 1 ) + {ⅇ}^{- j {\hat{θ}}_{n - L - N + 1}^{( i )}} {z}_{\tilde{α}} ( n ) & ( 16 ) \\ {z}_{\tilde{α}} ( n ) = {ⅇ}^{- j {\tilde{θ}}_{n - L}} {\int }_{nT}^{( n + 1 )} r ( τ ) {ⅇ}^{- jθ ( τ , \tilde{α} )} ⅆ τ & ( 17 ) \\ {\tilde{θ}}_{n - L} = π {\sum }_{k = n - L + N + 2}^{n - L} {\hat{α}}_{k} {h}_{( k )} mod 2 π & ( 18 )\end{matrix}$$

It will be understood by those skilled in the art that an important difference between Equations (11)-(13) and Equations (16)-(18) is that N−1 symbols have been removed from the cumulative phase \hat{θ}_{n-L-N+1}⁽ⁱ⁾ to form \tilde{θ}_{n-L}, which is associated with the branch metric. Thus, as paths merge and survivors are determined, more options are kept open in the trellis. The number of states in this trellis is M^{L-N-2}.

As used hereinafter, the receiver defined in Equations (8)-(10) is denoted as “Receiver-A”, and the receiver defined in Equations (16)-(18) as “Receiver-B”. The skilled artisan will appreciate that Equations (11)-(13) define Receiver-B, wherein N=1. Both receivers have the parameter N, which is the multi-symbol observation length. Receiver-B is also parameterized by the forget factor α.

An alternate embodiment of Receiver-B is given by:
λ_{\tilde{α}}(n)=λ_{\tilde{α}}(n−1)+Re{e^{-j\hat{θ}}^{_{n−L−N+1}}^{⁽ⁱ⁾}z_{\tilde{α}}(n)Q*_{\tilde{α}}(n−1)} (19)
Q_{\tilde{α}}(n)=αQ_{\tilde{α}}(n−1)+(1−α)e^{-j\hat{θ}}^{_{n−L−−N+1}}^{⁽ⁱ⁾}z_{\tilde{α}}(n) (20)
The receiver defined in Equations (19)-(20) is denoted as “Receiver-C”. The skilled artisan will appreciate that Receiver-C is different from Receiver-B in that the cumulative metric λ_{\tilde{α}}(n)is real-valued, and the noncoherent phase is resolved by the phase reference Q_{\tilde{α}}(n). Those skilled in the art will understand that Receiver-C is similar to Receiver-B, such that Receiver-C is parameterized by the forget factor α and multi-symbol observation interval N. Receiver-C also uses the same variables, z_{\tilde{α}}(n), \hat{θ}_{n-L-N+1}⁽ⁱ⁾, and \tilde{θ}_{n-L}, as are found in Receiver-B. It will be apparent to the skilled artisan that due to the similarities between Receivers-B and -C, the performance results discussed below are given only for Receiver-B, but can be regarded as typical for Receiver-C.

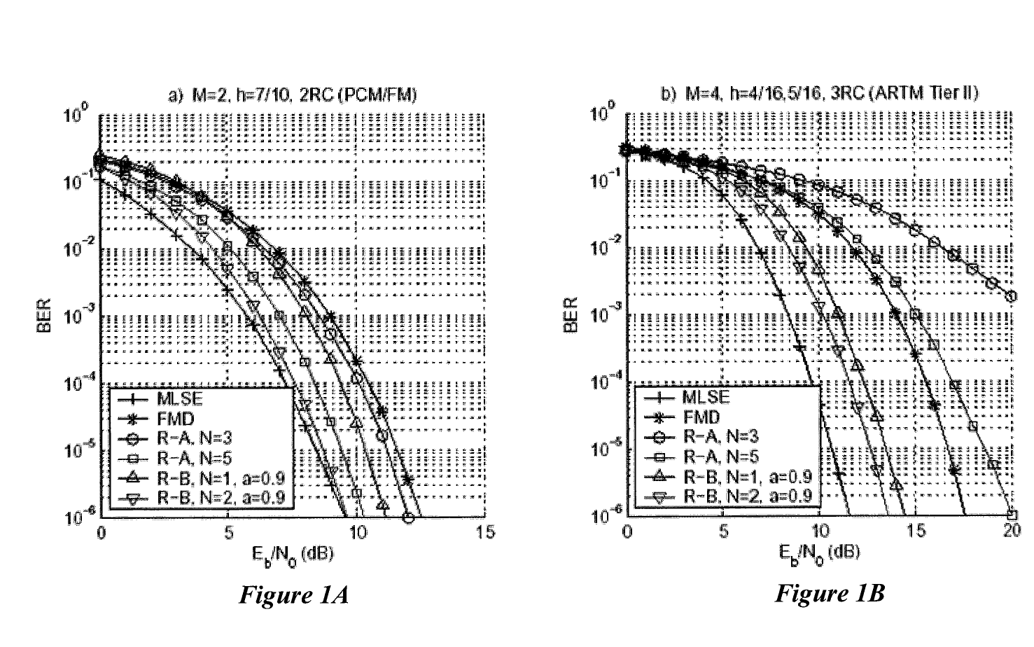

The first continuous phase modulation scheme considered is the PCM/FM waveform, which is M=2,h=7/10,2RC, illustrated as FIG. 1A. It will be understood by those skilled in the art that this is actually an approximation, where 2RC is very close to the standard fourth order Bessel pre-modulation filter. FIG. 1a illustrates two curves each for Receivers-A and -B, where the observation lengths are N=2, and α=0.9. Those skilled in the art will appreciate that the value of α=0.9 was found to yield the best receiver performance. The performance of the optimal maximum likelihood sequence estimating receiver is also shown as a reference. Receiver-A with N=5 yields an improvement of 2.5 dB over the traditional FM demodulator. FIG. 1a also shows that Receiver-B produces additional performance improvement over Receiver-A, in addition to requiring shorter observation intervals. At BER=10⁻⁶, Receiver-B with N=1 performs with 1 dB improvement over Receiver-A with N=3; these receivers have a trellis of 2 and 8 states respectively. A 0.7 dB improvement also exists for Receiver-B with N=2 (4 states) over Receiver-A with N=5 (32 states). FIG. 1A indicates that Receiver-B with N=2 performs very close to the optimal maximum likelihood sequence estimating receiver, which shows there is little to be gained by further increasing N for this continuous phase modulation scheme.

The next continuous phase modulation scheme in the simulations is the Advanced Range Telemetry Tier II waveform, which is M=4,h=7/10, {4/16, 5/16}, 3RC. FIG. 1B shows the same set of six curves in the previous PCM/FM example. Here the results are very different. Receiver-A is shown to perform at a loss relative to the FM demodulator. At BER=10⁻⁶ this loss is 1 dB for N=5, and 7 dB for N=3. This is a surprising result when considering that these receivers have 4096 and 256 states respectively. The sharp difference in the performance of Receiver-A for these two continuous phase modulation schemes would likely be explained by differences in distance properties of the two waveforms under noncoherent reception. It has been shown that some continuous phase modulation schemes require much larger values of N to achieve noncoherent performance close to the coherent case; however, analysis of this sort has not been performed for the Advanced Range Telemetry Tier II case at this time. For the case of Receiver-B, it outperforms the FM demodulator by several dB at BER=10⁻⁶, and is only 2 and 3 dB inferior to the optimum maximum likelihood sequence estimating receiver for N=2 and N=1 respectively (64 and 16 states each).

Up to this point, consideration has only been given to the performance with respect to the case of perfect symbol timing and carrier phase. Since the motivation for a noncoherent receiver is the case where the carrier phase is not known and assumed to be varying, a simple model will be introduced for variations in the carrier phase. Let
φₙ=φ(nT)=φₙ₋₁+vₙmod2π (19)
where {vₙ} are independently and identically distributed Gaussian random variables with zero mean and variance δ². This models the phase noise as a first order Markov process with Gaussian transition probability distribution. For perfect carrier phase tracking, δ=0.

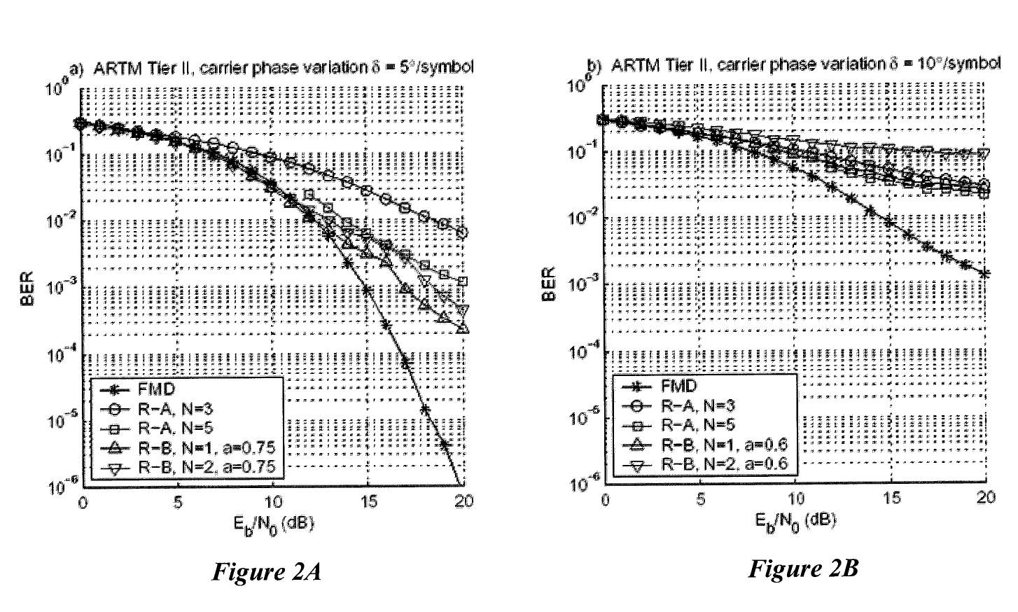

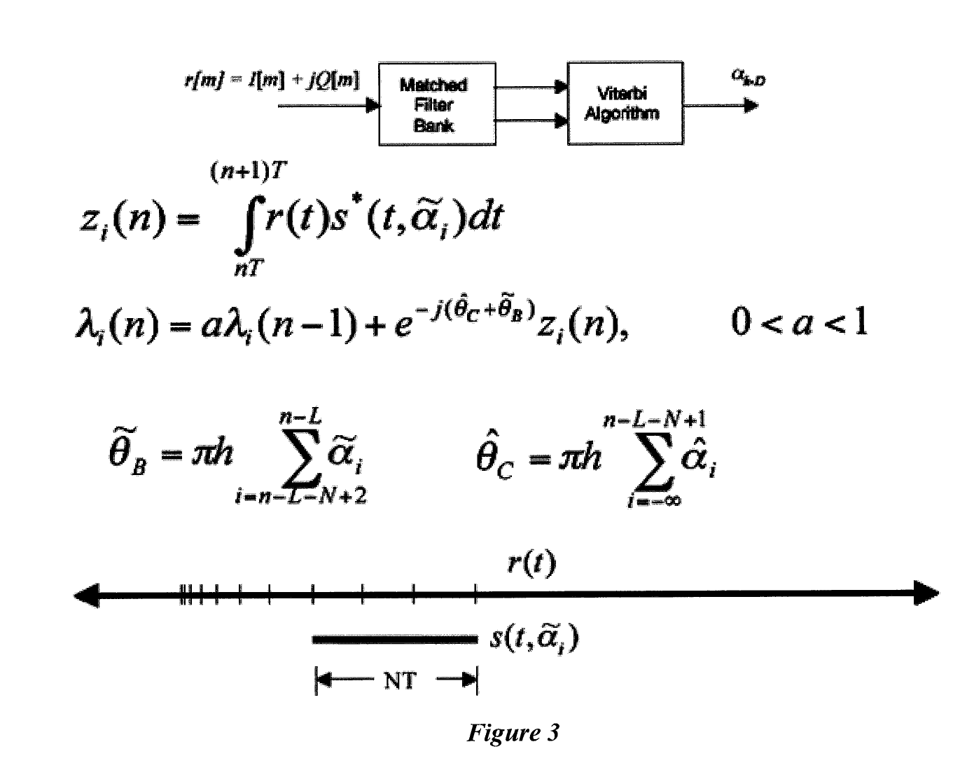

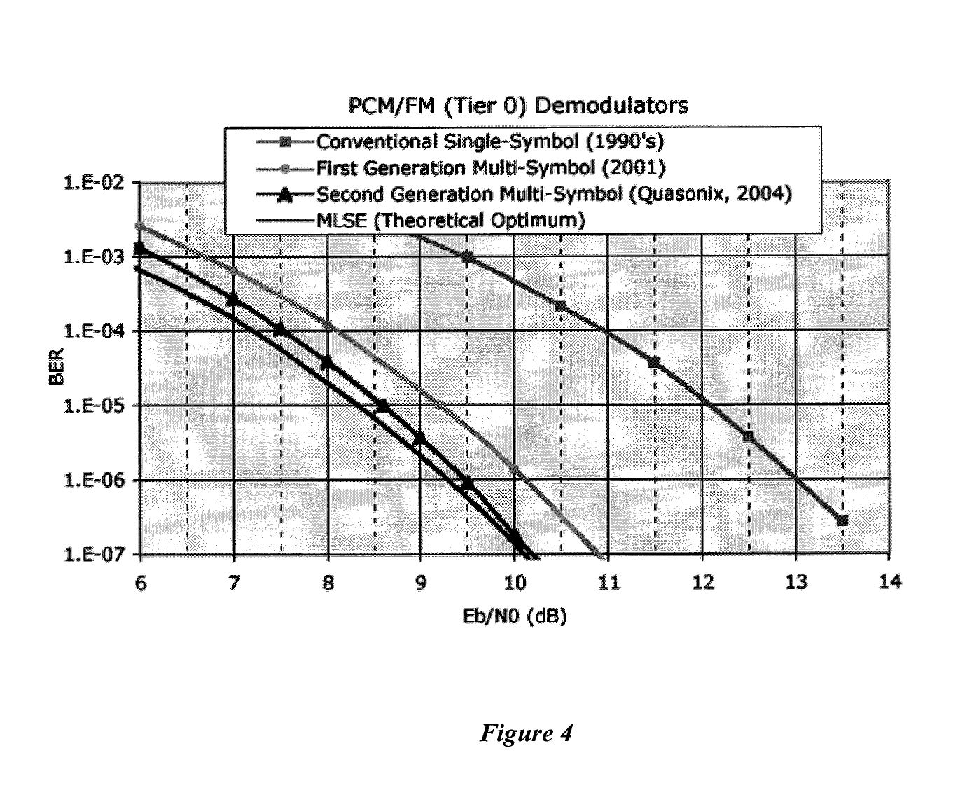

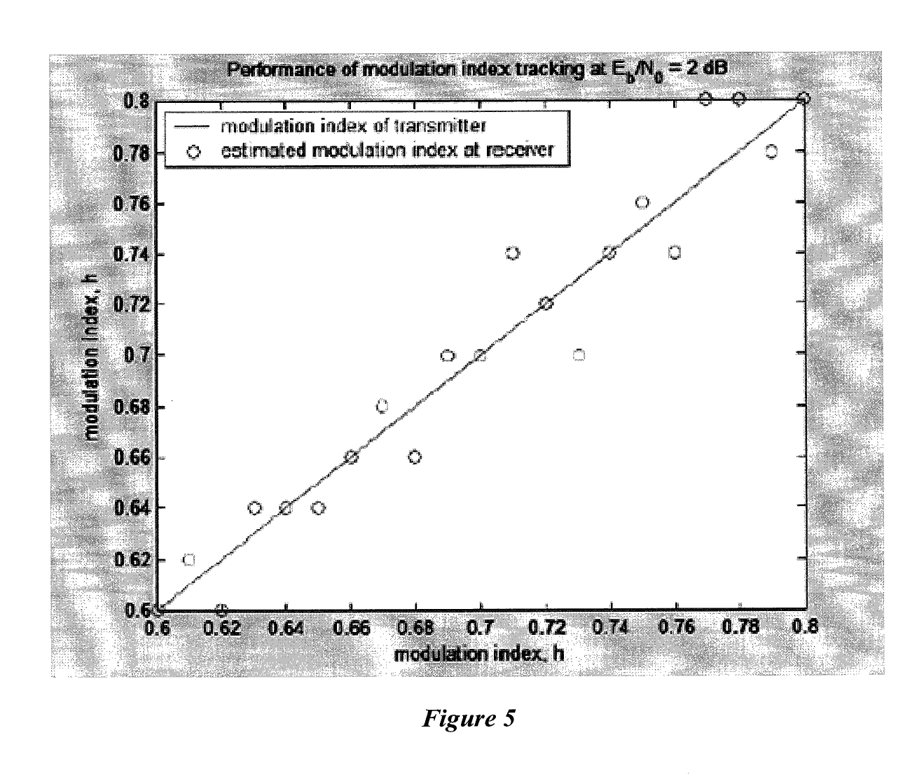

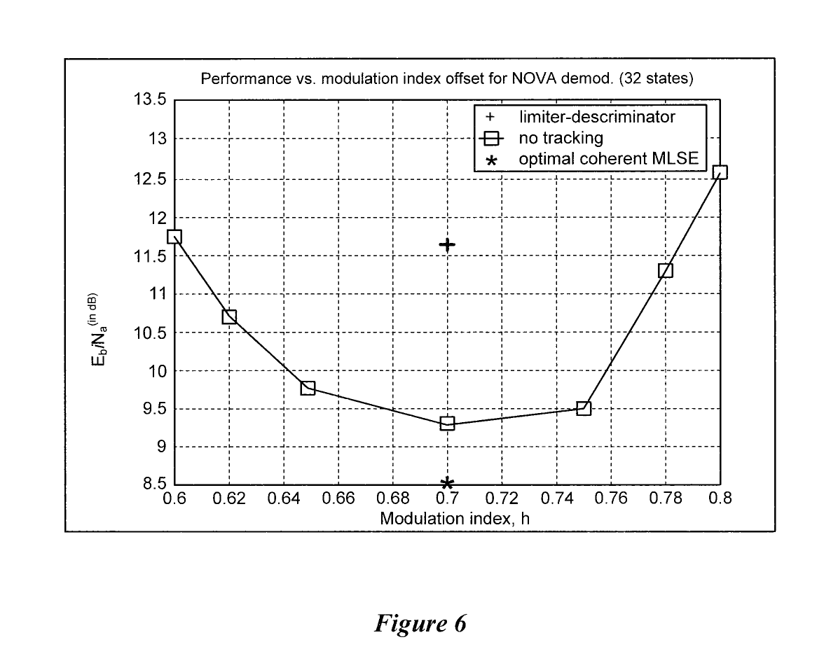

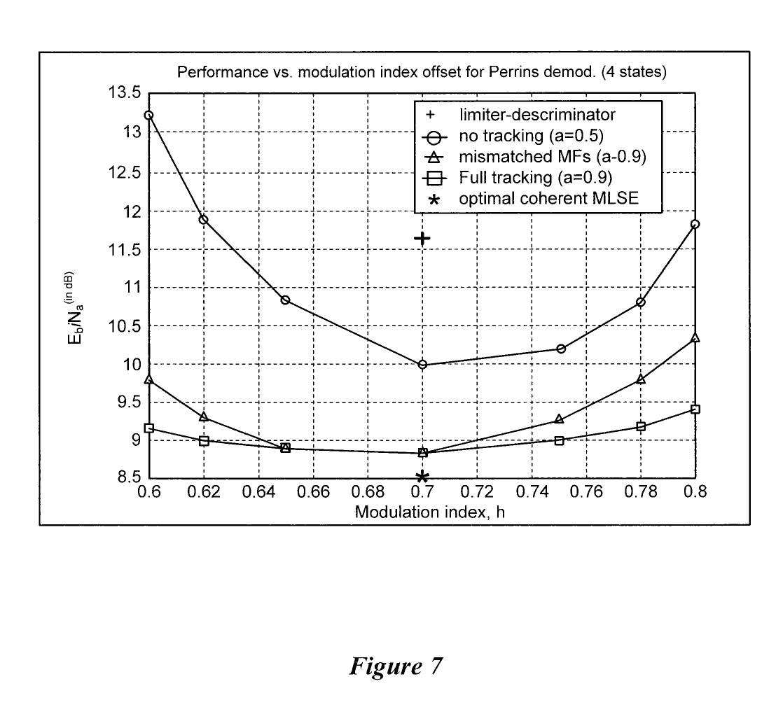

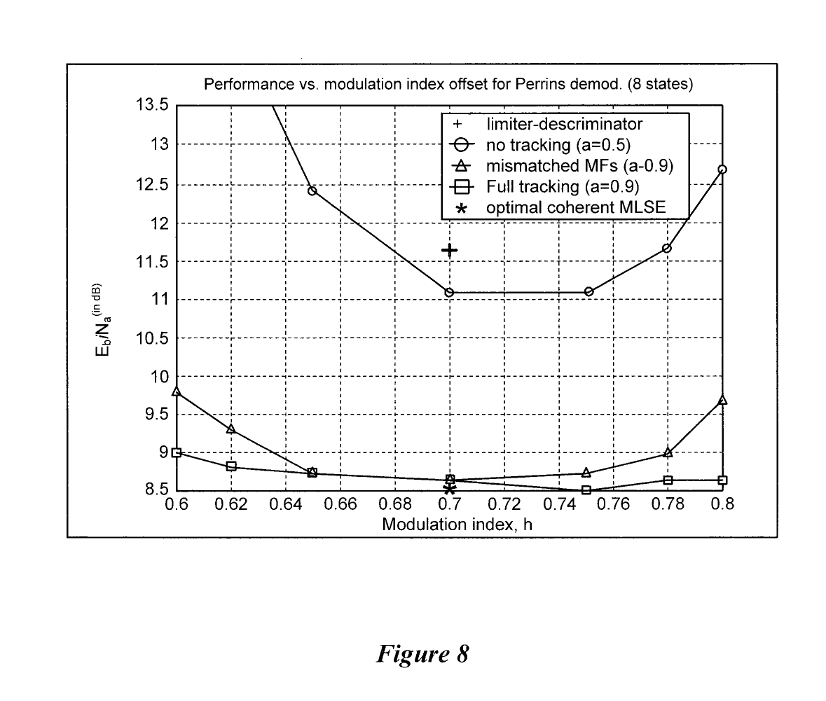

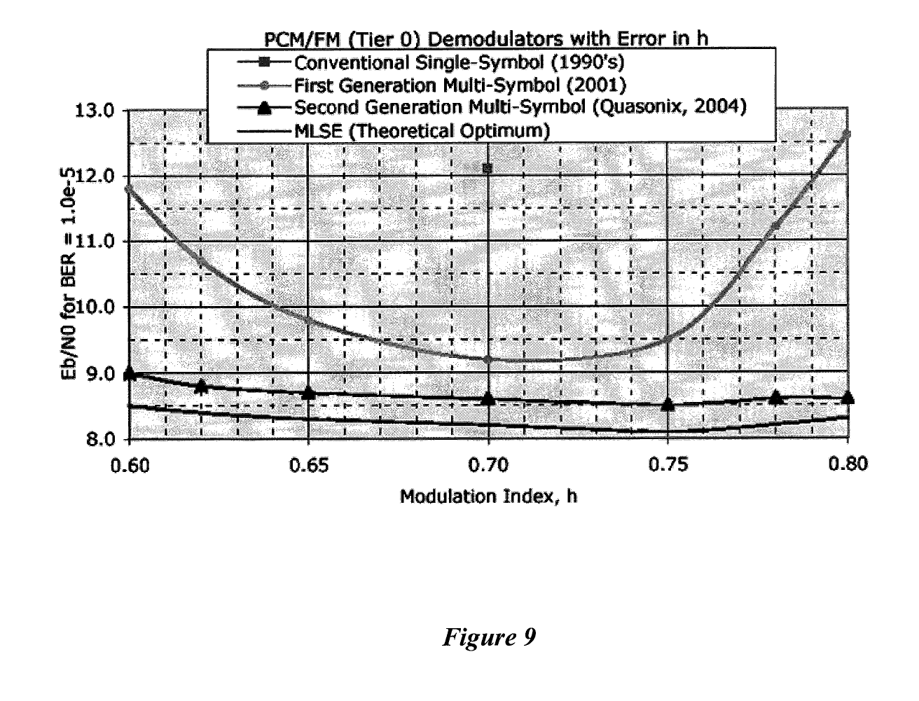

FIG. 2A shows the performance of the Advanced Range Telemetry Tier II waveform with the two receivers for the case where δ=5°/symbol. Among the noncoherent receivers, the traditional FM demodulator performs the best for this particular channel model. What is particularly interesting is that in the case of Receiver-B, the shorter observation interval (N=1) outperforms the longer one (N=2). Also, a lower value of α=0.75 was found to yield the best performance under these channel conditions. These performance characteristics of Receiver-B would appear to be a result of the very structure of the receiver. Under these channel conditions, lowering the value of the forget factor reduces the dependence of the branch metrics on previous noisy observations. Increasing the observation length under these channel conditions would only exacerbate the situation by increasing the reliance on previous noisy observations. FIG. 2B shows that when δ is increased to 10°/symbol the performance of Receiver-B with N=2 is the worst (note that α was further reduced to 0.6). For both values of δ, Receiver-B with N=1 (2 states) outperformed Receiver-A with N=5 (4096 states), and the FM demodulator outperformed them all.

The invention extends to computer programs in the form of source code, object code, partially compiled or otherwise, and code intermediate sources, or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical, electromagnetic, or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

Having thus described the invention, it is now claimed:

1. A continuous phase modulation detector comprising:
receiver means adapted for receiving digitally modulated signals having a generally continuous phase;
observation means adapted for performing multi-symbol observations on received digitally modulated signals;
memory means adapted for storing historic observation data corresponding to multi-symbol observations performed by the observation means; and
adjustment means adapted for selectively adjusting the receiver means in accordance with stored historic observation data.

2. The continuous phase modulation detector of claim 1, wherein the receiver means is noncoherent.

3. The continuous phase modulation detector of claim 2 wherein the adjustment means includes means for selectively adjusting the receiver means recursively in accordance with cumulatively acquired observation data.

4. The continuous phase modulation detector of claim 3 further comprising means adapted for selectively pruning the cumulatively acquired observation data in accordance with a selected pruning factor.

5. A method of continuous phase modulation detection comprising the steps of:
receiving digitally modulated signals having a generally continuous phase;
performing multi-symbol observations on received digitally modulated signals;
storing historic observation data corresponding to multi-symbol observations performed by the observation means; and
selectively adjusting the receiver means in accordance with stored historic observation data.

6. The method of continuous phase modulation detection of claim 5 further comprising the step of selectively adjusting the receiver means recursively in accordance with cumulatively acquired observation data.

7. The method of continuous phase modulation detection of claim 6 further comprising the step of selectively pruning the cumulatively acquired observation data in accordance with a selected pruning factor.
